(19) United States
(12) Patent Application Publication
(10) Pub. No.: US 2002/0131410 A1
(43) Pub. Date: Sep. 19, 2002

(54) Method and arrangements for addressing communication devices

(76) Inventors: Francois Erasmy, (US); Robert Jedlitschka, Munchen (DE)

Correspondence Address: MORRISON & FOERSTER LLP, 2000 PENNSYLVANIA AVE, NW, SUITE 5500, WASHINGTON, DC, 20006-1888, US

(21) Appl. No.: 09/798,929

(22) Filed: Mar. 6, 2001

(30) Foreign Application Priority Data
Mar. 6, 2001 (DE) GR 00P8027
Mar. 6, 2000 (DE) 100 10 949.7

(51) Int. Cl. H04L 12/28

(52) U.S. Cl. 370/389; 370/386

(57) ABSTRACT

To address a communication device KE in a communication network KN in which the associated communication devices KE are addressed using network addresses A_{OSI} which have a first format F₁, a network address A_{IP1} having a second format F₂, which is different than the first format F₁, is stipulated, this network address A_{IP1} is used to form a network address A_{OSI} which is matched to the first format F₁, and the matched network address A_{OSI} is allocated to the communication device KE for the purpose of addressing the latter in the communication network KN.

To transmit information in a targeted manner between communication devices connected to one another by communication networks, the communication devices need to be addressed uniquely. To this end, each communication device in each communication network with which it is associated is usually allocated a unique network address. Such an interconnection of communication devices associated with a particular communication network is also called a “domain” or “region” in specialist circles.

The number of communication devices associated with a domain is usually limited. Consequently, present-day network structures have a large number of domains connected to one another by network gateway devices. Network gateway devices are special communication devices which are associated with at least two domains at the same time and, in each, have a network address which is unique to the respective domain. They are also called gateways or routers.

Usually, different communication networks use different rules for transmitting information. These rules are also called “protocols”. They are used, for example, for controlling addressing, transmission, switching, authentication or prioritization methods used in information transmission. On the basis of the OSI (Open Systems Interconnection) reference model proposed by the ISO (International Organization for Standardization), protocols are respectively assigned to one of a plurality of protocol layers. There are seven layers in all, with transmission in communication networks being regulated in the bottom four layers. In this context, Layer 1—also called Physical Layer—is assigned point-to-point transmission between two line terminating devices via physical conductors, such as copper cables, optical fibers or air; Layer 2—also called Control Layer—is assigned the handling of transmission errors in Layer 1; Layer 3—also called Network Layer—is assigned routing in a meshed network of switching devices; and Layer 4—also called Transport Layer—is assigned the handling of errors in the layers below it, and also the control of targeted information transmission between two communication terminals. For each of the layers, the OSI proposes protocols, which are also called “OSI protocols” below.

Each communication device associated with a communication network has at least one Layer 1 protocol and usually at least one Layer 2 protocol, the services of the Layer 1 protocol being used by the Layer 2 protocol. Communication devices which have only protocols up to Layer 2 are called, by way of example, bridges, hub, Layer 2 switch or converter, according to their function, and communication devices in the form of network gateway devices having protocols up to Layer 4 are called, by way of example, gateway, Layer 3/4 switch or router. Each of these communication devices thus have a large number of protocols layered on the basis of the OSI reference model. Such a layering of protocols is also called a “protocol stack”.

The illustrated structural design of communication networks means that ascertaining unique network addresses for, by way of example, gateways between domains having different Layer 3 protocols takes the form of a complex network management task.

In this context, a separate address plan is usually provided for each domain. On the basis of this domain-specific address plan, a network address formatted on the basis of the rules of the Layer 3 protocol used in a domain is generally ascertained for and allocated to each communication device in the domain.

It is an object of the invention to improve the ascertainment and allocation of network addresses. The object is achieved by the features of patent claim 1.

The fundamental aspect of the invention is a method for allocating a network address to a communication device in a communication network in which the associated communication devices are addressed using network addresses which have a first format, where a network address having a second format, which is different than the first format, is stipulated, this network address is used to form a network address which is matched to the first format, and the matched network address is allocated to the communication device for the purpose of addressing the latter in the communication network.

A few fundamental advantages of the invention are mentioned below:

irrespective of the format requirements of a domain having an associated communication device, it is always possible to stipulate network addresses having a standard format, since only the matched network addresses need to satisfy the rules of the Layer 3 protocol used in the respective domain.

it becomes easier to ascertain network addresses, since at least some of the matched network addresses are stipulated automatically.

the likelihood of erroneous network addresses is reduced, since, if the network address is stipulated correctly, the automatically matched network address is by definition correct.

the matched network addresses' address space need not be managed if the network addresses are stipulated without conflict.

In accordance with one variant of the method according to the invention, in the case of a communication device in the form of a network gateway device to another communication network, in which the associated communication devices are addressed using network addresses which have the second format, a further network address, which has the second format, is stipulated and is allocated to the network gateway device for the purpose of addressing the latter in the other communication network—claim 2. This makes it easier to ascertain the network addresses, since, in spite of different formats and address spaces, only network addresses having a single format and a standard address space are formed.

In accordance with one refinement of the method according to the invention, addressing takes place in the first communication network on the basis of the rules of an OSI protocol—claim 5. In particular, when the OSI protocol is in the form of a Connectionless Network Protocol (CLNP), the matched network address is formed by allocating a hexadecimal value 0×31 for a prefix in the form of an Authority and Format Identifier (AFI), and the stipulated network address is added to a subsequent Domain Specific Part—claim 6. The use of the AFI 0×31 characterizing private addresses prevents address conflicts between the—preferably automatically formed—matched network addresses and the remainder of the network addresses provided in the address space in the protocol CLNP.

In accordance with one variant of the method according to the invention, the second format takes the form of a format for forming Internet addresses—claim 7. In particular, addressing takes place in the second communication network on the basis of the rules of an IP protocol—claim 8. This means that methods which have been found to be advantageous can be used to prevent address conflicts between the stipulated Internet addresses. In combination with the AFI 0×31 characterizing private addresses in the protocol CLNP, matched network addresses are thus formed which are inherently free of address conflicts within the matched network addresses' address space.

Other advantageous refinements of the invention can be found in the subsidiary or coordinate claims.

The invention is explained in more detail below with the aid of illustrative embodiments which are shown in a number of figures, in which:

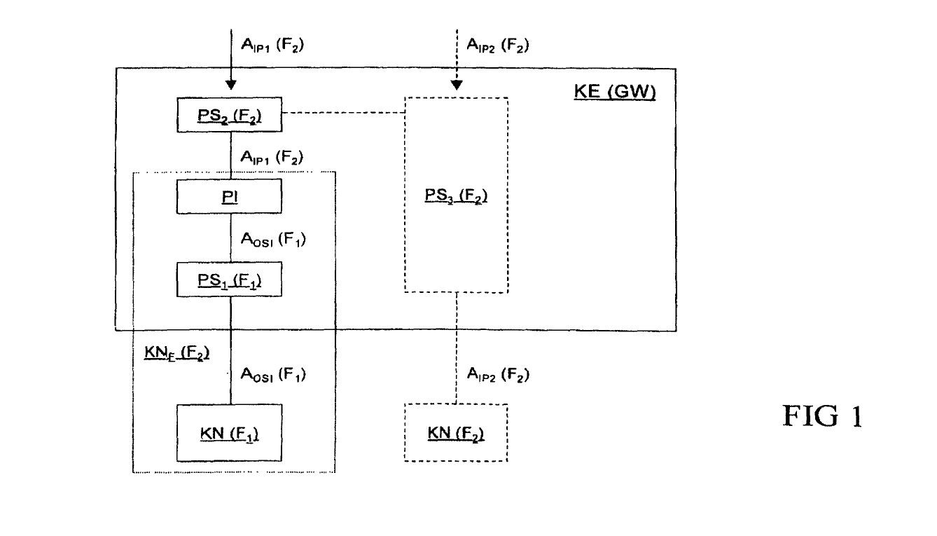

FIG. 1 shows a block diagram schematically illustrating a communication device according to the invention,

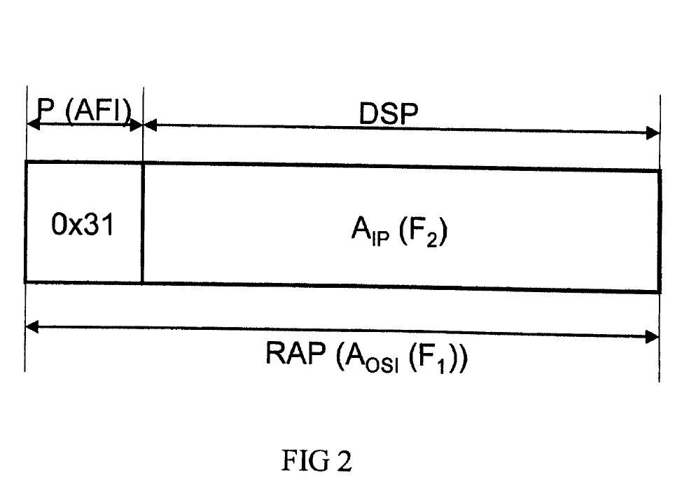

FIG. 2 shows a network address format based on the OSI protocol CLNP,

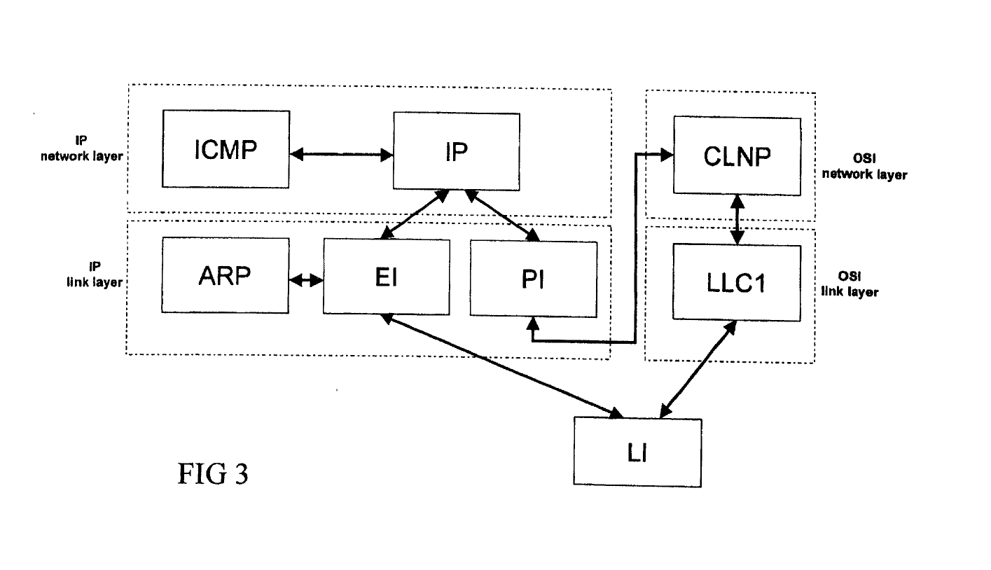

FIG. 3 shows two protocol stacks connected to one another in accordance with the invention, and

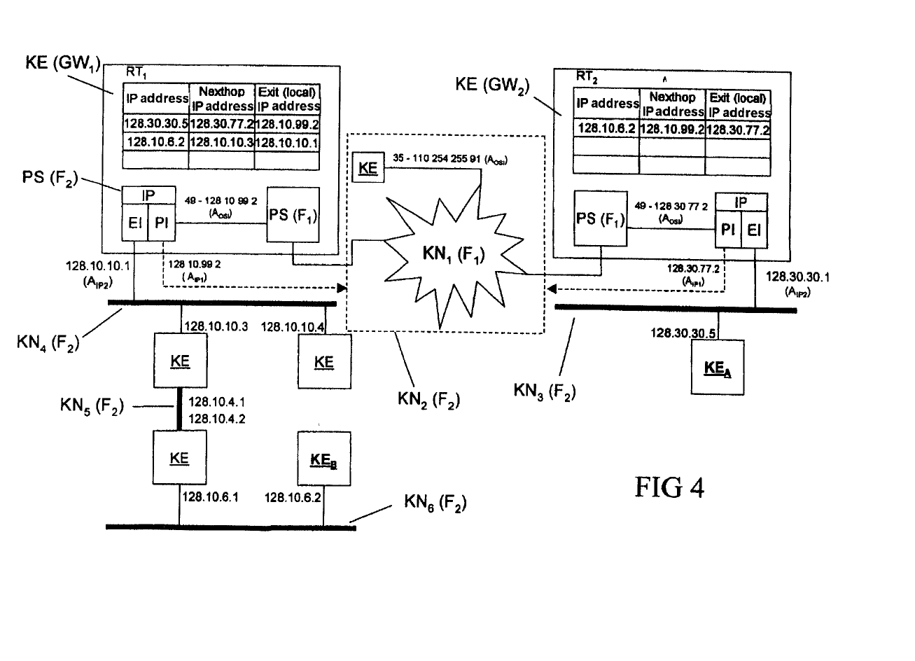

FIG. 4 shows an interconnection of communication networks having two communication devices in the form of network gateway devices.

FIG. 1 shows, by way of example, an inventive communication device KE having at least one first protocol stack PS₁ (F₁) for connection to a first communication network KN₁ (F₁) using network addresses A_{OSI} having a first format F₁. When information is transmitted, network addresses A_{OSI} (F₁) having the first format F₁ are transmitted between the first protocol stack PS₁ and the communication network KN₁. In addition, at least one second protocol stack PS₂ (F₂) is provided for connection to an imaginary second communication network KN₂ (F₂) using network addresses A_{IP} having a second format F₂. The two protocol stacks PS are connected to one another by an adapter PI. The adapter PI interchanges network addresses A_{OSI} having the first format F₁ with the first protocol stack PS₁. For the second protocol stack PS₂, the adapter PI acts as the imaginary communication network KN₂ (F₂), i.e. network addresses A_{IP} having the second format F₂ are interchanged, amongst other things. Thus, the adapter PI converts the network addresses A between the two formats F₁ and F₂. To configure the network address A_{OSI} of the communication device KE in the communication network KN₁ (F₁), only the network address A_{IP1}, which has the second format F₂ and is associated with the second protocol stack PS₂, is stipulated and communicated.

Provided that the communication device is in the form of a network gateway device GW, at least one third protocol stack PS₃ (F₂) will be provided and will be connected to a third communication network KN₃ (F₂), having network addresses A in the second format F₂. To configure the further network address A_{IP2} of the network gateway device GW in the communication network KN₃, a further network address A_{IP2}, which has the second format F₂ and is associated with the further second protocol stack PS₂, is stipulated and communicated. The two protocol stacks PS₂ and PS₃ are connected to one another for the purpose of transmitting information between the communication networks KN₁ (F₁) and KN₃ (F₂).

FIG. 2 shows a network address format based on the OSI protocol CLNP. Such a network address has a prefix P, preferably in the form of an Authority and Format Identifier AFI with the value 0×31, followed by a Domain Specific Part DSP, to which, according to the invention, network addresses A_{IP} (F₂) having the second format F₂ are added to form network addresses A_{OSI} having the first format F₁. This is also called a Reachable Address Prefix RAP.

FIG. 3 shows illustrative refinements of the protocol stacks PS₁ and PS₂ connected to one another with an adapter PI in accordance with the invention. In this case, the first protocol stack PS₁ comprises, by way of example, the OSI protocols CLNP and LLC1 layered above one another. The second protocol stack PS₂ has the IP protocols IP and ICMP, which are arranged next to one another, associated with it. The adapter PI is arranged between the protocols IP and CLNP. An optionally provided third protocol stack PS₃ has, by way of example, the protocols IP and EI, which are layered above one another. In this context, within their respective layer, the protocol IP has the associated protocol ICMP, and the protocol EI has the associated protocol ARP. All the protocol stacks PS access the physical line using the Layer 1 protocol LI, i.e. the communication devices are associated with communication networks on a logically abstract level (by analog protocol stacks PS), and not on a physical level (by cabling).

FIG. 4 shows, by way of example, an interconnection of six communication networks Knᵢ, 1<=i<=6, with the communication network KN₁ using network addresses A having the first format F₁, and the communication networks KN₂-KN₆ using network addresses having the second format F₂. The second communication network KN₂ is merely in the form of an imaginary, virtual communication network KN whose information streams are tunneled by the first communication network KN₁, i.e. two protocols in the same layer are encapsulated with one another such that the data of the first protocol are packed into the data packets of the second protocol. The following communication networks KN are connected to one another by means of communication devices KE in the form of network gateway devices GW: KN₁ to KN₃, KN₁ to KN₄, KN₄ to KN₅, and KN₅ to KN₆. In this context, a network gateway device GW₁ of the inventive design is provided between the communication networks KN₁ and KN₃, and a network gateway device GW₂ of the inventive design is provided between the communication networks KN₁ and KN₄. The network gateway devices GW each have at least two protocol stacks PS connected to one another by means of an adapter PI.

The communication networks KN₂-KN₆ have, by way of example, network addresses A_{IP} designed on the basis of an Internet protocol IP. The following address spaces are provided:

in communication network KN₂: 128.xxx.xxx.xxx

in communication network KN₃: 128. 30. 30.xxx

in communication network KN₄: 128. 10. 10.xxx

in communication network KN₅: 128. 10. 4.xxx

in communication network KN₆: 128. 10. 6.xxx

In the communication network KN₁, the addressing takes place using network addresses A_{OSI} based on the OSI protocol CLNP i.e. network addresses A_{OSI} having a prefix P 0×31 (hexadecimal)=49 (decimal) contain a Domain Specific Part DSP, which can be used without restriction on the basis of the prescribed format F₁. In addition, the communication network KN₁ has another associated communication device KE having a network address A_{OSI}=35 110 254 255 91, i.e. this network address A_{OSI} contains no prefix P in the form of an Authority and Format Identifier AFI.

The invention will be explained by way of example using the network scenario shown in FIG. 4. In this case, the network gateway devices GW₁, GW₂ are allocated network addresses A on the basis of the method according to the invention, the aim being to be able to transmit information between a communication device KE_{A} associated with the communication network KN₃ using network address A_{IP}=128.30.30.5 and a communication device KE_{B} associated with the communication network KN₆ using network address A_{IP}=128.10.6.2.

The invention means that exclusively network addresses A_{IP} having a format F₂ based on the Internet protocol IP are stipulated. Advantageously, no stipulation, i.e. address planning, of network addresses A_{OSI} having the first format F₁ is therefore required. For the network gateway device GW₁, the network address A_{IP1}=128.10.99.2 is stipulated for the imaginary communication network KN₂, and the network address A_{IP2}=128.10.10.1 is stipulated for the communication network KN₄; for the network gateway device GW₂, the network address A_{IP1}=128.30.77.2 is stipulated for the imaginary communication network KN₂, and the network address A_{1P2}=128.30.30.1 is stipulated for the communication network KN₃. All stipulated network addresses A_{IP} are communicated to the respective network gateway devices GW.

From this, according to the invention, the network address A_{OSI}=49-12810992 of the network gateway device GW₁ in the communication network KN₁ is formed in the network gateway device GW₁ by adding the prefix P, which is in the form of an Authority and Format Identifier AFI and has the value 0×31—see also FIG. 2. In the same way, the network gateway device GW₂ forms its network address A_{OSI}=49-12830772 in the communication network KN₂.

On account of the conflict-free address allocation of the Internet network addresses A_{IP}, the two OSI network addresses A_{OSI} formed are likewise conflict-free. The different prefix P means that there is also no address conflict with the network address A_{OSI}=35-11025425591 of the further communication device KE associated with the communication network KN₁.

In addition, the routing tables RT of the two network gateway devices GW require no OSI network addresses A_{OSI} to be entered. Hence, routing tables RT containing Internet network addresses A_{IT} can be used, said routing tables having been found to be advantageous. By way of example, the following entries in the routing tables RT are provided for the above information transmission between the two communication devices KE_{A} and KE_{B}:

In the network gateway device GW₁:

| DESTINATION | | |
|---|---|---|
| ADDRESS | NEXT HOP | LOCAL EXIT (GW₁) |
| 128.30.30.5 (KN₃ | 128.30.77.2 (KN₂ | 128.10.99.2 (KN₂ |
| (KE_{A})) | (GW₂)) | (GW₁)) |
| 128.10.6.2 (KN₆ | 128.10.10.3 (KN₄) | 128.10.10.1 (KN₄ |
| (KE_{B})) | | (GW₁)) |

and in the network gateway device GW₂:

| DESTINATION | | |
|---|---|---|
| ADDRESS | NEXT HOP | LOCAL EXIT (GW₂) |
| 128.10.6.2 (KN₆ | 128.10.99.2 (KN₂ | 128.30.77.2 (KN₂ |
| (KE_{B})) | (GW₁)) | (GW₁)) |

Hence, the two routing tables contain only Internet addresses A_{IP}, i.e. for the imaginary communication network KN₂.

Information is now transmitted between the two communication devices KE_{A} and KE_{B} on the basis of the routing methods customary on the Internet.

Finally, it should be pointed out that the invention can be used in any desired type of communication network KN. By way of example, use is envisaged in

long-haul communication networks KN, such as the Internet,

local communication networks KN—also called Local Area Network or LAN,

virtual communication networks KN, such as a Virtual Private Network—also called VPN—or such as the prioritized sub-network in a DiffServ network.

1. A method for allocating a network address (A) to a communication device (KE) in a communication network (KN₁) in which the associated communication devices (KE) are addressed using network addresses (A) which have a first format (F₁), having the following steps:
a network address (A_{IP1}) having a second format (F₂), which is different than the first format (F₁), is stipulated,
this network address (A_{IP1}) is used to form a network address (A_{OSI}) which is matched to the first format (F₁),
the matched network address (A_{OSI}) is allocated to the communication device (KE) for the purpose of addressing the latter in the communication network (KN₁).

2. The method as claimed in claim 1, wherein,
In the case of a communication device (KE) in the form of a network gateway device (GW) to another communication network (KN₂), in which the associated communication devices (KE) are addressed using network addresses (A) which have the second format (F₃), a further network address (A_{IP2}), which has the second format, is stipulated and is allocated to the network gateway device (GW) for the purpose of addressing the latter in the other communication network (KN₂).

3. The method as claimed in one of claims 1 or 2, wherein,
the matched network address (A_{OSI}) contains the stipulated network address (A_{IP1}) in unmodified form.

4. The method as claimed in one of claims 1 to 3, wherein,
the matched network address (A_{OSI}) is formed by adding a prefix (P) to the stipulated network address (A_{IP1}).

5. The method as claimed in one of the preceding claims, wherein,
addressing takes place in the first communication network (KN₁) on the basis of the rules of an OSI protocol (OSI).

6. The method as claimed in claims 4 and 5, wherein,
when the OSI protocol (OSI) is in the form of a Connectionless Network Protocol (CLNP), the matched network address (A_{OSI}) is formed by allocating a hexadecimal value 0×31 for a prefix (P) in the form of an Authority and Format Identifier (AFI), and the stipulated network address (A_{IP1}) is added to a subsequent Domain Specific Part (DSP).

7. The method as claimed in one of the preceding claims, wherein,
the second format (F₂) takes the form of a format (F) for forming Internet addresses (A_{IP}).

8. The method as claimed in one of the preceding claims, wherein,
addressing takes place in the second communication network (KN₂) on the basis of the rules of an IP protocol (IP).

9. An arrangement for carrying out a method as claimed in one of the preceding claims.

10. A communication device (KE) having:
at least one first protocol stack (PS₁) for linking the communication device (KE) to a first communication network (KN₁), whose associated communication devices (KE) are addressed using network addresses (A) which have a first format (F₁),
at least one second protocol stack (PS₂) for virtually linking the communication device (KE) to a second communication network (KN₂), whose associated communication devices (KE) are addressed using network addresses (A) which have a second format (F₂),
at least one adapter (PI) for connecting the two protocol stacks (PS₁, PS₂), which respectively matches at least the transmitted network addresses (A) in each direction such that they subsequently correspond to the format (F) of the network addresses (A) in that communication network (KN) for which the respectively receiving protocol stack (PS) is designed.
